(19) United States
(12) Patent Application Publication
(10) Pub. No.: US 2024/0256867 A1
(43) Pub. Date: Aug. 1, 2024

(54) NEURAL NETWORK SYSTEM THAT EXECUTES BATCH NORMALIZATION

(71) Applicant: Konica Minolta, Inc., Tokyo (JP)

(72) Inventor: Taiki Sekii, Takatsuki-shi, Osaka (JP)

(73) Assignee: Konica Minolta, Inc., Tokyo (JP)

(21) Appl. No.: 18/560,798

(22) PCT Filed: Sep. 24, 2021
(86) PCT No.: PCT/JP2021/034961

§ 371 Date: Nov. 14, 2023

(30) Foreign Application Priority Data
Jun. 9, 2021 (JP) 2021-096588

(51) Int. Cl. G06N 3/08

(52) U.S. Cl. CPC G06N 3/08

(57) ABSTRACT

A neural network system includes: a first layer generating first layer outputs of pieces of training data; a second layer; and a numerical conversion layer. During training, the numerical conversion layer: receives the first layer outputs from the first layer, calculates a numerical conversion parameter corresponding to each of the pieces of training data, numerically converts each of components of each of the first layer outputs using the numerical conversion parameter to generate a numerical conversion layer output, and inputs the same to the second layer. The numerical conversion parameter corresponding to one of the pieces of training data is: calculated from the first layer outputs of the pieces of training data except the one of the pieces of training data, or calculated by weighting one of the first layer outputs of the pieces of training data including the one of the pieces of training data.

### BACKGROUND

### Technical Field

The present disclosure relates to a technique of enhancing a learning effect of a neural network.

### Description of Related Art

A neural network is used for image recognition, natural language processing, speech recognition, and the like. The neural network is a machine learning model that predicts an output for an input using a plurality of layers. In the neural network, the output of each layer is used as the input of the next layer of the network.

As a technique of enhancing the learning effect of such a neural network, a technique called batch normalization has been proposed (see, for example, Patent Literature 1).

### PATENT LITERATURE

Patent Literature 1: JP 6453477 B

Batch normalization is a technique that contributes to learning stabilization and an improvement in learning speed by, in batch learning in which a plurality of pieces of training data are collectively processed, calculating a statistical value of a layer output, which is a batch normalization target, for each batch and normalizing the layer output using the calculated statistical value so as to obtain a mean of 0 and a variance of 1. However, in batch normalization, in a case where the batch size (the number of training data in one batch) is small, the effect of batch normalization is reduced, and learning may not proceed well.

### SUMMARY

One or more embodiments of the present disclosure provide a neural network system capable of efficiently learning even in a case where a batch size is small.

A neural network system according to an aspect of the present disclosure is a neural network system that is implemented by one or more computers, the neural network system includes: a first layer that generates first layer outputs of a plurality of pieces of training data, each of the first layer outputs having a plurality of components; a second layer; and a numerical conversion layer disposed between the first layer and the second layer, during training of the neural network system, the numerical conversion layer receives the first layer outputs from the first layer, calculates a numerical conversion parameter corresponding to each of the pieces of training data, numerically converting each of the components of each of the first layer outputs using the numerical conversion parameter to generate a numerical conversion layer output, and inputs the numerical conversion layer output to the second layer, and the numerical conversion parameter corresponding to one of the pieces of training data is calculated from the first layer outputs of the pieces of training data except the one of the pieces of training data, or is calculated by weighting each of the first layer outputs of each of the pieces of training data including the one of the pieces of training data, and a weight of one of the first layer outputs of the one of the pieces of training data is smaller than a weight of the other first layer outputs of the other pieces of training data.

In the neural network system, the numerical conversion parameter corresponding to the one of the pieces of training data may be calculated from first layer outputs of a plurality of pieces of training data selected, from a batch including a set of the pieces of training data including the one of the pieces of training data, by a predetermined selection method to exclude the one of the pieces of training data.

In the neural network system, the components of each of the first layer outputs may be indexed by dimensions, and the numerical conversion layer calculates the numerical conversion parameter by: with respect to the pieces of training data per the batch, calculating, for each of the dimensions, a mean of the components for the dimension of each of the first layer outputs of the pieces of training data selected by the selection method as a pseudo mean of the components for the dimension of each of the first layer outputs, and calculating, for each of the dimensions, a variance of the components for the dimension of each of the first layer outputs using the components for the dimension of each of the first layer outputs and the pseudo mean with respect to the pieces of training data per the batch.

In the neural network system, the numerical conversion layer generates the numerical conversion layer output by, for each of the pieces of training data, numerically converting the components of each of the first layer outputs of the pieces of training data using the pseudo mean and the variance for each of the dimensions corresponding to each of the components.

In the neural network system, the numerical conversion layer generates the numerical conversion layer output by transforming the component numerically converted based on values of a set of transformation parameters for each of the dimensions.

In the neural network system, after the neural network system is trained, the numerical conversion layer may receive a new first layer output for a new neural network input generated by the first layer, generate a new numerically converted layer output by numerically converting each of components of the new first layer output using a precalculated numerical conversion parameter, generates a new numerical conversion layer output by converting, for each of the dimensions, each of components of the new numerically converted layer output based on a set of transformation parameters for each of the dimensions, and newly input the new numerical conversion layer output to the second layer.

In the neural network system, the precalculated numerical conversion parameter may be calculated from the first layer outputs generated by the first layer during training of the neural network system.

In the neural network system, the precalculated numerical conversion parameter may be calculated from the new first layer output generated by the new first layer after the neural network system is trained.

In the neural network system, a new neural network input processed by the neural network system after the neural network system is trained may be an input of a different type from the pieces of training data used to train the neural network system.

In the neural network system, the components of each of the first layer outputs may be indexed by a feature index and a spatial location index, and the numerical conversion layer calculates the numerical conversion parameter by, with respect to pieces of training data per the batch, calculating, for each combination of the feature index and the spatial location index, a mean of the components for the combination of each of the first layer outputs of the pieces of training data selected by the selection method, with respect to the pieces of training data per the batch, calculating, for each of the feature index, an arithmetic mean of the mean with respect to the combination including the feature index, calculating, for each combination of the feature index and the spatial location index, a variance of the components for the combination of each of the first layer outputs using the components for the combination of each of the first layer outputs and the arithmetic mean of the mean with respect to the pieces of training data per the batch, and calculating, for each of the feature index, an arithmetic mean of the variance with respect to the combination including the feature index.

In the neural network system, the numerical conversion layer generates the numerical conversion layer output by, for each of the pieces of training data, numerically converting the components of each of the first layer outputs of the pieces of training data using the arithmetic mean of the mean and the arithmetic mean of the variance.

In the neural network system, the numerical conversion layer generates the numerical conversion layer output by converting the component numerically converted based on a set of transformation parameters for each of the feature index.

In the neural network system, after the neural network system is trained, the numerical conversion layer may receive a new first layer output for a new neural network input generated by the first layer, generate a new numerically converted layer output by numerically converting each component of the new first layer output using a precalculated numerical conversion parameter, generate a new numerical conversion layer output by converting, for each of the feature index, each of components of the new numerically converted layer output based on a set of transformation parameters for each of the feature index, and newly inputs the new numerical conversion layer output to the second layer.

In the neural network system, the components of each of the first layer outputs may be indexed by a feature index and a spatial location index, and the numerical conversion layer calculates the numerical conversion parameter by, with respect to the pieces of training data per the batch, calculating, for each of the feature indexes, a mean of the components for the feature index of each of the first layer outputs of the pieces of training data selected by the selection method as a pseudo mean of the components for the feature index of each of the first layer outputs, and calculating, for each of the feature index, a variance of the components for the feature index of each of the first layer outputs using the components for the feature index of each of the first layer outputs and the pseudo mean with respect to the pieces of training data per the batch.

In the neural network system, generating the numerical conversion layer output may include, for each of the pieces of training data, numerically converting the component of each of the first layer outputs of the pieces of training data using the pseudo mean and the variance for a feature index corresponding to each component.

In the neural network system, the numerical conversion layer generates the numerical conversion layer output by transforming the component numerically converted based on values of a set of transformation parameters for each of the feature index.

In the neural network system, after the neural network system is trained, the numerical conversion layer may receive a new first layer output for a new neural network input generated by the first layer, generate a new numerically converted layer output by numerically converting each of components of the new first layer output using a precalculated numerical conversion parameter, generate a new numerical conversion layer output by converting, for each of the feature index, each of components of the new numerically converted layer output based on a set of transformation parameters for each of the feature index, and newly input the new numerical conversion layer output to the second layer.

In the neural network system, the first layer may generate each of the first layer outputs by modifying a first layer input based on a set of parameters for the first layer.

In the neural network system, the second layer may generate a second layer output by applying a non-linear operation to a batch normalization layer output.

In the neural network system, the first layer is a first neural network layer that may generate each of the first layer outputs by modifying a first layer input based on current values of a set of parameters to generate a modified first layer input, and then applying a non-linear operation to the modified first layer input.

In the neural network system, during the training of the neural network system, the neural network system may back propagate the numerical conversion parameter for partially adjusting a value of a parameter of the neural network system.

In the neural network system, the predetermined selection method may select, from a batch, some pieces of training data except for the one of the pieces of training data, or all the pieces of training data. A method may comprise: executing an operation implemented by numerical conversion layer described above.

A non-transitory computer readable storage storing instructions executed by one or more computers, the instructions causing the one or more computers to function as the neural network described above.

According to the neural network system of the present disclosure, learning efficiency can be improved even in a case where the batch size is small.

### BRIEF DESCRIPTION OF DRAWINGS

FIG. 1 is a block diagram illustrating a configuration of a neural network system 200.

FIG. 2 is a diagram illustrating an example of a data structure of a training data group 300.

FIG. 3 is a diagram for explaining an input of a numerical conversion layer 220 and an output of a numerical conversion layer 220 in the neural network system 200 during inference.

FIG. 4 is a diagram for explaining an input of the numerical conversion layer 220 and an output of the numerical conversion layer 220 in the neural network system 200 during training.

FIG. 5 is a diagram illustrating an example of a method of calculating a pseudo mean.

FIG. 6 is a diagram illustrating an example of a method of calculating a pseudo variance.

FIG. 7 is a diagram illustrating an example of a numerical conversion method of a first layer output.

FIG. 8 is a diagram illustrating an example of a flow for generating a numerical conversion layer output during training of the neural network system 200.

FIG. 9 is a diagram illustrating an example of a flow for generating a numerical conversion layer output when an inference result for a new input is generated after the neural network system 200 is trained.

FIG. 10 is a diagram illustrating a modification of the method of calculating the pseudo mean.

FIG. 11 is a diagram illustrating a modification of the method of calculating the pseudo mean.

FIG. 12 is a diagram illustrating a modification of the method of calculating the pseudo mean.

### DETAILED DESCRIPTION OF EMBODIMENTS

### 1. First Embodiment

Hereinafter, a neural network system 200 according to a first embodiment will be described.

### 1.1 Configuration

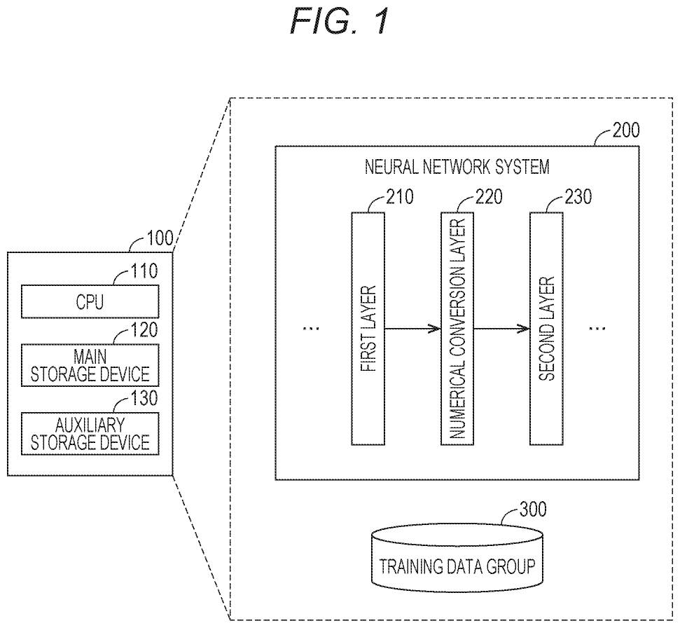

FIG. 1 is a block diagram illustrating a configuration of a neural network system 200. As illustrated in the figure, the neural network system 200 is implemented by one or more computers 100 including a CPU 110, a main storage device 120, and an auxiliary storage device 130. Computer programs and data stored in the auxiliary storage device 130 are loaded into the main storage device 120, and by the CPU 110 operating in accordance with the computer programs and data loaded into the main storage device 120, the neural network system 200 is implemented. As an example, the auxiliary storage device 130 includes a hard disk. The auxiliary storage device 130 may include a nonvolatile semiconductor memory.

The neural network system 200 includes a plurality of neural network layers arranged in sequence. The plurality of neural network layers include a first layer 210, a numerical conversion layer 220, and a second layer 230. An input to the neural network system 200 is input to the lowest neural network layer, the output of each layer is the next layer input, and the output of the highest layer is the output of the neural network system 200.

Each neural network layer performs calculations using parameters on data including a plurality of components received as an input to generate an output having a plurality of components. These parameters are predetermined by learning (training) of the neural network system 200.

The neural network system 200 can use any digital data having a plurality of components as an input and is configured to output any inference results based on the input.

For example, the input of the neural network system 200 may be image data, audio data, or text data, and may be feature data extracted from image data, audio data, or text data.

In a case where the input to the neural network system 200 is image data or feature data extracted from image data, the output of the neural network system 200 may be a score for each of a plurality of objects (the likelihood that the object is estimated to be included in the image data).

In a case where the input to the neural network system 200 is audio data or feature data extracted from audio data, the output of the neural network system 200 may be a score for each of a plurality of keywords (the likelihood that the keyword is estimated to be uttered in the audio data).

In a case where the input to the neural network system 200 is text data or feature data extracted from text data, the output of the neural network system 200 may be a score for each of a plurality of topics (the likelihood that the topic is estimated to be the subject of the text data).

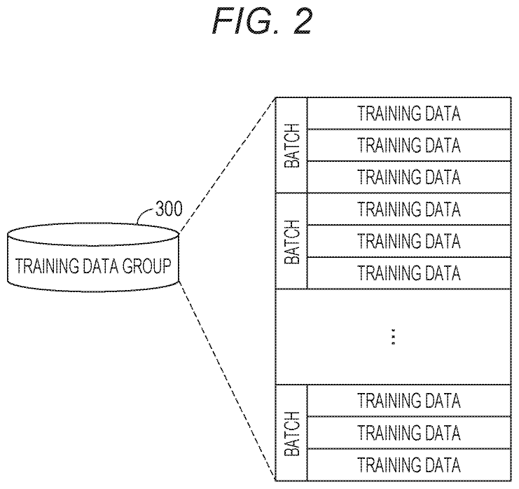

The auxiliary storage device 130 stores a training data group 300 used for learning of the neural network system 200. As illustrated in FIG. 2, the training data group 300 has a data structure including a plurality of batches each of which includes a plurality of pieces of training data. Here, the batch size is described as three, but the batch size is not limited to three. Each of the training data is digital data having a plurality of components, as described above.

The neural network system 200 performs training using each training data included in the training data group 300 to determine parameters for each neural network layer, and processes the newly received input data in each neural network layer using the parameters determined in the training to output an inference result for the new input data.

The neural network system 200 includes the numerical conversion layer 220 instead of a batch normalization layer in a neural network system that performs conventional batch normalization, and performs numerical conversion processing instead of batch normalization processing. Other parts are similar to those of the neural network system that performs conventional batch normalization (see, for example, Patent Literature 1), and description thereof is omitted.

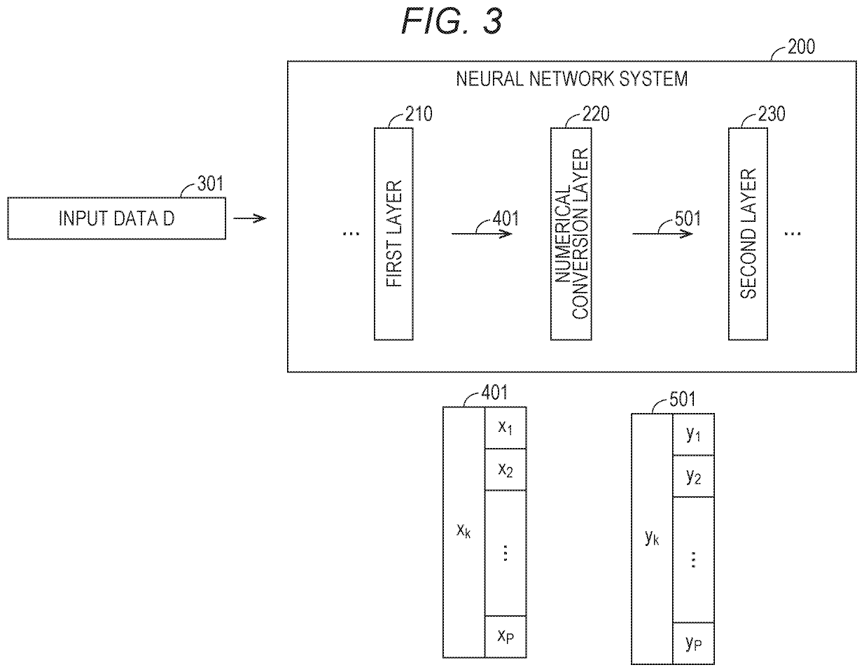

FIG. 3 is a diagram for explaining an output of the first layer 210 (an input of the numerical conversion layer 220) and an input of the second layer 230 (an output of the numerical conversion layer 220) in the neural network system 200 during inference.

As illustrated in the figure, the first layer 210 outputs a first layer output 401 (first layer output x) for new input data 301 (input data D) and inputs the first layer output to the numerical conversion layer 220. The numerical conversion layer 220 outputs a numerical conversion layer output 501 (numerical conversion layer output y) for the first layer output x and inputs the numerical conversion layer output to the second layer 230.

The first layer 210 is a layer that generates an output including a plurality of (for example, P) components indexed by dimension. That is, in FIG. 3, the first layer output x has P components (x₁, x₂, . . . , x_{P}) individually corresponding to the P dimensions. In addition, the numerical conversion layer output y has P components (y₁, y₂, . . . , y_{P}) individually corresponding to the P dimensions.

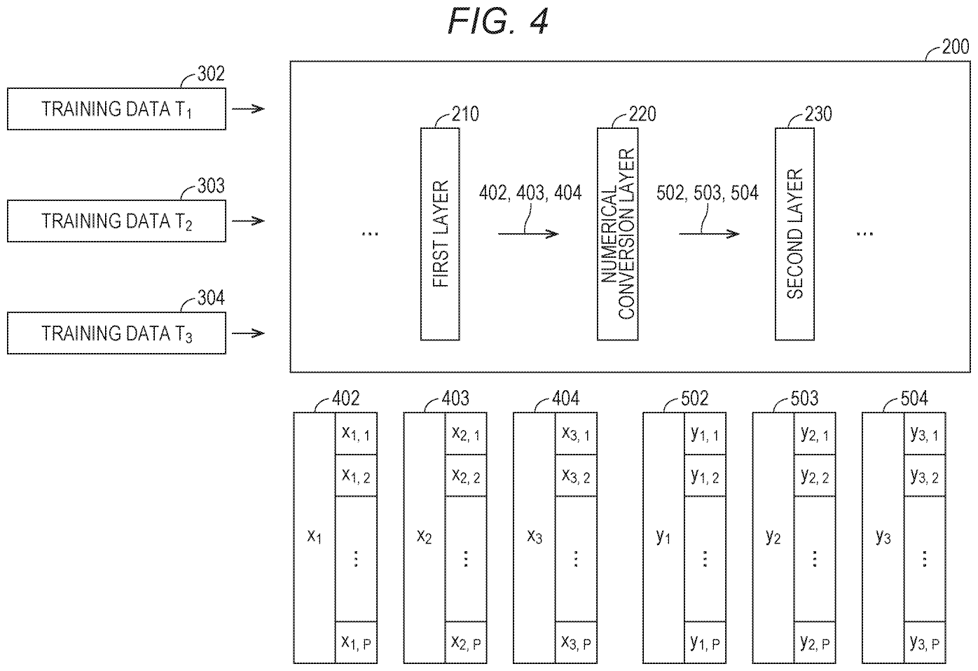

FIG. 4 is a diagram for explaining an output of the first layer 210 and an input of the second layer 230 in the neural network system 200 during training.

As illustrated in the figure, in order to perform batch learning that collectively processes a plurality of pieces of training data, the first layer 210 outputs first layer outputs 402, 403, and 404 (first layer outputs x1, x2, and x3) for training data 302, 303, and 304 (training data T₁, T₂, and T₃) and inputs the first layer outputs to the numerical conversion layer 220. The numerical conversion layer 220 outputs numerical conversion layer outputs 502, 503, and 504 (numerical conversion layer outputs y₁, y₂, and y₃) for the first layer outputs x1, x2, and x3, and inputs the numerical conversion layer outputs to the second layer 230.

In FIG. 4, the first layer output x1 has P components (x_{1,1} x_{1,2}, . . . , x_{1,P}) individually corresponding to the P dimensions. Similarly, the first layer output x₂ has P components (x_{2,1}, x_{2,2}, . . . , x_{2,P}) individually corresponding to the P dimensions, and the first layer output x₃ has P components (x_{3,1}, x_{3,2}, . . . , x_{3,P}) individually corresponding to the P dimensions. In addition, the numerical conversion layer output y₁ has P components (y_{1,1} y_{1,2}, . . . , y_{1,P}) individually corresponding to the P dimensions. Similarly, the numerical conversion layer output y₂ has P components (y_{2,1}, y_{2,2}, . . . , y_{2,P}) individually corresponding to the P dimensions, and the numerical conversion layer output y₃ has P components (y_{3,1}, y_{3,2}, . . . , y_{3,P}) individually corresponding to the P dimensions.

A conventional batch normalization layer normalizes, for each dimension, a component of a first layer output corresponding to the dimension by using statistical parameters. The numerical conversion layer 220 of the present disclosure also numerically converts, for each dimension, a component of the first layer output corresponding to the dimension by using numerical conversion parameters.

Hereinafter, a method of calculating the numerical conversion parameters calculated in the numerical conversion layer 220 during training will be described. The numerical conversion layer 220 calculates a pseudo mean for each training data and calculates a pseudo variance for each batch. A method of calculating the pseudo mean and the pseudo variance corresponding to the p-th dimension will be described. The pseudo means and the pseudo variances corresponding to other dimensions are similarly calculated.

By performing batch learning, the numerical conversion layer 220 receives a component 411 (component x_{1,p}), a component 412 (x_{2,p}), and a component 413 (x_{3,p}) for the p-th dimension of the first layer outputs corresponding to training data 311, 312, 313 (training data T₁, T₂, and T₃).

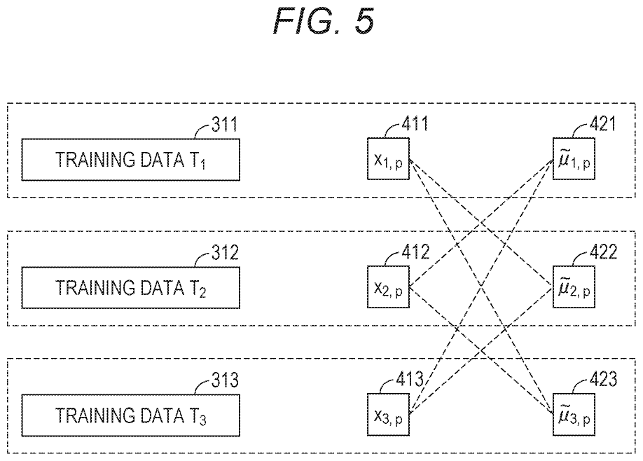

FIG. 5 illustrates a method of calculating a pseudo mean calculated for each training data.

A pseudo mean 421 corresponding to the training data T1 is calculated by the following formula using x_{2,p} and x_{3,p} except for x_{1,p} corresponding to the training data T1, among x_{1,p}, x_{2,p}, and x_{3,p} received by the numerical conversion layer 220.

$${\tilde{μ}}_{1 , p} = \frac{1}{2} ( {x}_{2 , p} + {x}_{3 , p} ) \qquad [ Mathematical Formula 1 ]$$

A pseudo mean 422 corresponding to the training data T2 is calculated by the following formula using x_{1,p} and x_{3,p} except for x_{2,p} corresponding to the training data T2, among x_{1,p}, x_{2,p}, and x_{3,p} received by the numerical conversion layer 220.

$${\tilde{μ}}_{2 , p} = \frac{1}{2} ( {x}_{1 , p} + {x}_{3 , p} ) \qquad [ Mathematical Formula 2 ]$$

A pseudo mean 423 corresponding to the training data T3 is calculated by the following formula using x_{1,p} and x_{2,p} except for x_{3,p} corresponding to the training data T3, among x_{1,p}, x_{2,p}, and x_{3,p} received by the numerical conversion layer 220.

$${\tilde{μ}}_{3 , p} = \frac{1}{2} ( {x}_{1 , p} + {x}_{2 , p} ) \qquad [ Mathematical Formula 3 ]$$

In this manner, as the pseudo mean corresponding to one piece of training data of the plurality of pieces of training data in the batch, the mean of the components of the first layer outputs of the other training data except for the one piece of training data in the batch is calculated.

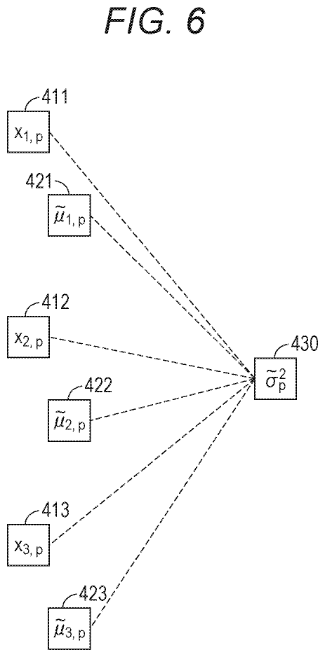

FIG. 6 illustrates a method of calculating a pseudo variance calculated for each batch.

A pseudo variance 430 is calculated by the following formula using x_{1,p}, x_{2,p}, and x_{3,p} received by the numerical conversion layer 220 and the calculated pseudo means 421, 422, and 423.

$$[ Mathematical Formula 4 ]$$

$${\tilde{σ}}^{2} = \frac{1}{3} \{ {( {x}_{1 , p} - {\tilde{μ}}_{1 , p} )}^{2} + {( {x}_{2 , p} - {\tilde{μ}}_{2 , p} )}^{2} + {( {x}_{3 , p} - {\tilde{μ}}_{3 , p} )}^{2} \}$$

In this manner, the pseudo variance is calculated by calculating the formula for obtaining variance in the statistics using the difference between the first layer output and the corresponding pseudo mean instead of the deviation between each sample value (each component of the first layer output) and the mean.

The numerical conversion layer 220 performs numerical conversion on the components of the first layer output using the pseudo mean and the pseudo variance calculated in this manner to generate a numerical conversion output.

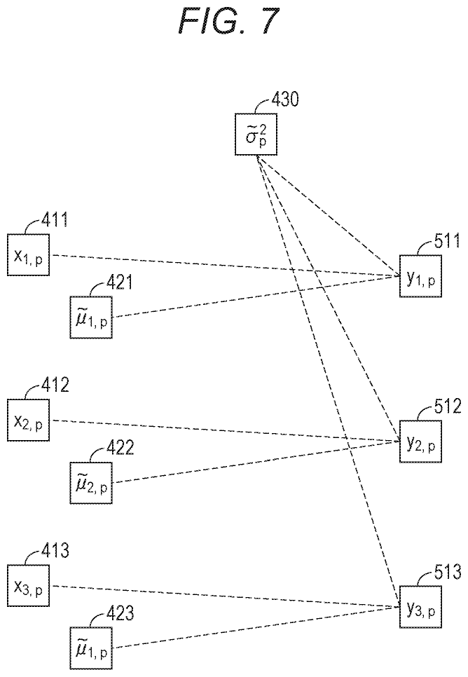

FIG. 7 illustrates a method of generating a numerical conversion output. For example, the first layer output 411 corresponding to the training data T1 is numerically converted by the following formula to generate a numerical conversion layer output 511.

$${y}_{1 , p} = \frac{{x}_{1 , p} - {\tilde{μ}}_{1 , p}}{\tilde{σ}} \qquad [ Mathematical Formula 5 ]$$

Similarly, the first layer output 412 corresponding to the training data T2 is numerically converted by the following formula to generate a numerical conversion layer output 512.

$${y}_{2 , p} = \frac{{x}_{2 , p} - {\tilde{μ}}_{2 , p}}{\tilde{σ}} \qquad [ Mathematical Formula 6 ]$$

In addition, the first layer output 413 corresponding to the training data T3 is numerically converted by the following formula to generate a numerical conversion layer output 513.

$${y}_{3 , p} = \frac{{x}_{3 , p} - {\tilde{μ}}_{3 , p}}{\tilde{σ}} \qquad [ Mathematical Formula 7 ]$$

During training, the numerical conversion layer 220 performs the numerical conversion, that is, subtracts the corresponding pseudo mean from the first layer output and divides it by the positive square root of the pseudo variance to calculate the numerical conversion layer outputs 511, 512, 513, and provide these outputs to the second layer. By performing the numerical conversion on the first layer output using the pseudo mean and the pseudo variance instead of the mean and variance in the conventional neural network system, as in the conventional neural network system, the numerical conversion layer outputs 511, 512, and 513 are normalized so as to obtain a mean of 0 and a variance of 1, and efficiency of the learning effect can be enhanced.

### 1.2 Operation

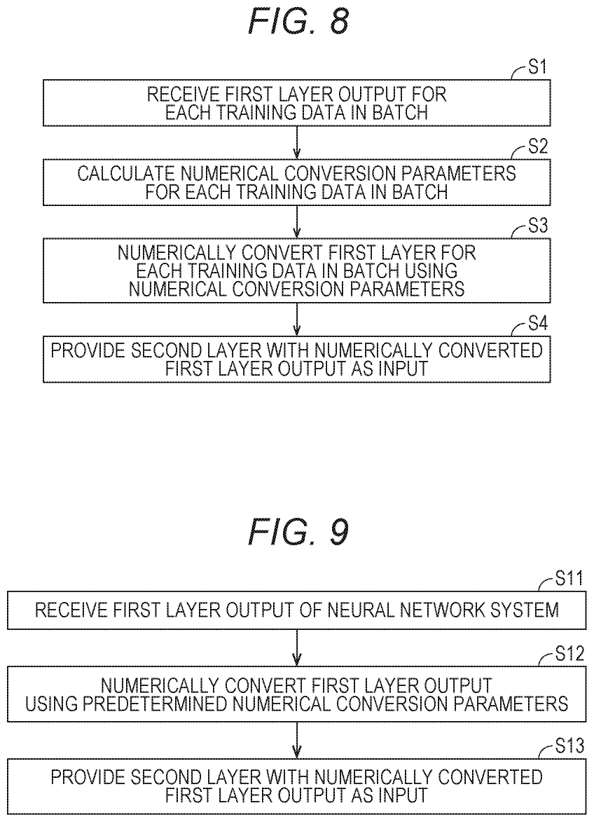

FIG. 8 is a diagram illustrating an example of a flow for generating a numerical conversion layer output during training of the neural network system 200.

The numerical conversion layer 220 receives a first layer output (step S1). The first layer output includes an individual output generated by the first layer 210 for each training data in a batch.

The numerical conversion layer 220 calculates numerical conversion parameters (step S2). As the numerical conversion parameters, a pseudo mean is calculated for each training data in the batch, and a pseudo variance is calculated for the batch.

The numerical conversion layer 220 numerically converts the first layer output for each training data in the batch using the calculated numerical conversion parameters to generate a numerical conversion layer output (step S3).

The numerical conversion layer 220 provides a second layer with the numerical conversion layer output as an input (step S4).

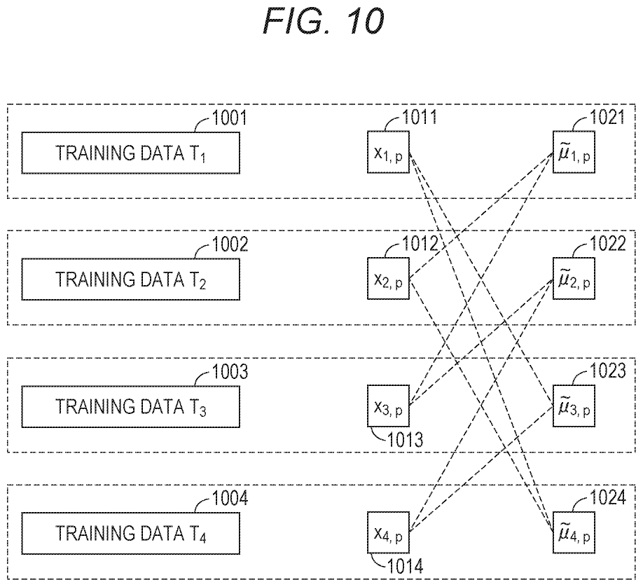

FIG. 9 is a diagram illustrating an example of a flow for generating a numerical conversion layer output when an inference result for a new input is generated after the neural network system 200 is trained.

The numerical conversion layer 220 receives a first layer output for a new output (step S11).

The numerical conversion layer 220 numerically converts the first layer output for the new input using predetermined numerical conversion parameters to generate a numerical conversion layer output (step S12). These numeral conversion parameters may be determined on the basis of the first layer output generated in the first layer 210 during training of the neural network system 200, or may be determined on the basis of the first layer output generated in the first layer 210 for another input data after training.

The numerical conversion layer 220 provides the second layer with a numerical conversion layer output for the new input as an input (step S13).

### 1.3 Effects

Focusing on each training data, in the conventional batch normalization, the first layer output of the training data of interest is always included in the calculation of the statistical values for normalization. In a case where the batch size is small, the proportion of the first layer output of the training data of interest in the calculation of the statistical values is large. Therefore, from the viewpoint of the training data of interest, the statistical values calculated from a less varying batch largely affected by its own value are used, and there is a possibility that the effect of normalization is reduced.

On the other hand, according to the method of the present disclosure, since the numerical conversion parameter (pseudo mean) for numerical conversion is calculated by excluding the first layer output of the training data of interest, the influence of its own value on the numerical conversion parameter can be suppressed, and the effect of numerical conversion (effect similar to normalization) is obtained even in a case where the batch size is small.

### 2. Supplements

Although the present disclosure has been described based on the embodiment, it is needless to say that the present disclosure is not limited to the above embodiment and that the following modifications are included in the technical scope of the present invention.

(1) In the above embodiment, the pseudo mean corresponding to one piece of training data of a plurality of pieces of training data in a batch is calculated using first layer outputs of all the other training data except for the one piece of training data in the batch, but it is not limited thereto. For example, the calculation may be performed using the first layer outputs of some selected training data among the other training data except for the one piece of training data in the batch.

FIG. 10 illustrates a method of calculating a pseudo mean different from that of the embodiment. Here, it is assumed that the batch size is four and the training data in a batch includes pieces of training data 1001, 1002, 1003, and 1004 (training data T1, T2, T3, and T4). A method of calculating the pseudo mean and the pseudo variance corresponding to the p-th dimension will be described, but the pseudo means corresponding to other dimensions are similarly calculated.

By performing batch learning, the numerical conversion layer 220 receives a component 1011 (component x_{1,p}), a component 1012 (x_{2,p}), a component 1013 (x_{3,p}), and a component 1014 (x_{4,p}) for the p-th dimension of the first layer outputs corresponding to the training data T1, T2, T3, and T4).

A pseudo mean 1021 corresponding to the training data T1 is calculated by the following formula using x_{2,p} and x_{3,p} selected from x_{2,p}, x_{3,p}, and x₄p except for x_{1,p} corresponding to the training data T1, among x_{1,p}, x_{2,p}, x_{3,p}, and x₄p received by the numerical conversion layer 220.

$${\tilde{μ}}_{1 , p} = \frac{1}{2} ( {x}_{2 , p} + {x}_{3 , p} ) \qquad [ Mathematical Formula 8 ]$$

A pseudo mean 1022 corresponding to the training data T2 is calculated by the following formula using x_{3,p} and x₄p selected from x_{1,p}, x_{3,p}, and x₄p except for x_{2,p} corresponding to the training data T2, among x_{1,p}, x_{2,p}, x_{3,p}, and x₄p received by the numerical conversion layer 220.

$${\tilde{μ}}_{2 , p} = \frac{1}{2} ( {x}_{3 , p} + {x}_{4 , p} ) \qquad [ Mathematical Formula 9 ]$$

A pseudo mean 1023 corresponding to the training data T3 is calculated by the following formula using x_{1,p} and x_{4,p} selected from x_{1,p}, x_{2,p}, and x₄p except for x_{3,p} corresponding to the training data T3, among x_{1,p}, x_{2,p}, x_{3,p}, and x₄p received by the numerical conversion layer 220.

$${\tilde{μ}}_{3 , p} = \frac{1}{2} ( {x}_{1 , p} + {x}_{4 , p} ) \qquad [ Mathematical Formula 10 ]$$

A pseudo mean 1024 corresponding to the training data T4 is calculated by the following formula using x_{1,p} and x_{2,p} selected from x_{1,p}, x_{2,p}, and x_{3,p} except for x₄p corresponding to the training data T4, among x_{1,p}, x_{2,p}, x_{3,p}, and x₄p received by the numerical conversion layer 220.

$${\tilde{μ}}_{4 , p} = \frac{1}{2} ( {x}_{1 , p} + {x}_{2 , p} ) \qquad [ Mathematical Formula 11 ]$$

In this manner, as the pseudo mean corresponding to one piece of training data of the plurality of pieces of training data in the batch, the mean of the components of the first layer outputs of the training data selected from the other training data except for the one piece of training data in the batch is calculated. In a method of selecting some training data from the other training data except for the one piece of training data, the training data may be selected randomly or may be selected in accordance with a predetermined rule. In the above example, the training data is selected in a manner that the mean of the pseudo means 1021 to 1024 matches the mean of the first layer outputs x_{1,p}, x_{2,p}, x_{3,p}, and x₄p.

In the conventional batch normalization, there is a possibility that the effect is reduced in a case where the batch size is extremely large, but according to this method, there is a possibility that a decrease in the effect due to the extremely large batch size can be suppressed.

(2) In the above embodiment, the pseudo mean corresponding to one piece of training data of a plurality of pieces of training data in a batch is calculated using first layer outputs of all the other training data except for the one piece of training data in the batch, but it is not limited thereto. For example, the pseudo mean may be calculated using the first layer output of the training data in another batch.

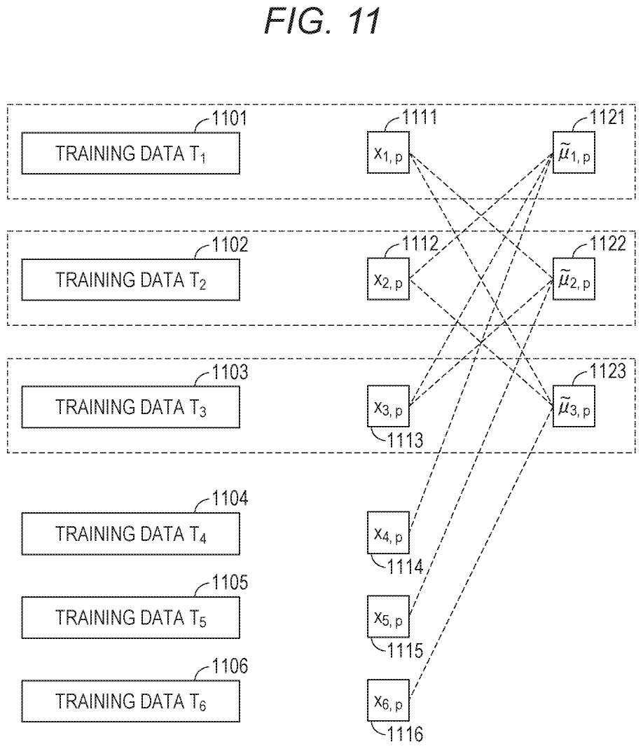

FIG. 11 illustrates a method of calculating a pseudo mean different from that of the embodiment. Here, it is assumed that the batch size is three, the training data of a first batch includes pieces of training data 1101, 1102, and 1103 (training data T1, T2, and T3), and the training data of a second batch includes pieces of training data 1104, 1105, and 1106 (training data T4, T5, and T6). A method of calculating the pseudo mean and the pseudo variance corresponding to the p-th dimension will be described, but the pseudo means corresponding to other dimensions are similarly calculated.

In the learning of the first batch, the numerical conversion layer 220 receives a component 1111 (component x_{1,p}), a component 1112 (x_{2,p}), and a component 1113 (x_{3,p}) for the p-th dimension of the first layer outputs corresponding to the training data T1, T2, and T3 of the first batch and a component 1114 (component x_{4,p}), a component 1115 (x_{5,p}), and a component 1116 (x_{6,p}) for the p-th dimension of the first layer outputs corresponding to the training data T4, T5, and T6 of the second batch.

A pseudo mean 1121 corresponding to the training data T1 is calculated by the following formula using x_{2,p}, x_{3,p}, and x₄p selected from x_{2,p}, x_{3,p}, x_{4,p}, x_{5,p}, and x_{6,p} except for x_{1,p} corresponding to the training data T1, among x_{1,p}, x_{2,p}, x_{3,p}, x_{4,p}, x_{5,p}, and x_{6,p} received by the numerical conversion layer 220.

$${\tilde{μ}}_{1 , p} = \frac{1}{3} ( {x}_{2 , p} + {x}_{3 , p} + {x}_{4 , p} ) \qquad [ Mathematical Formula 12 ]$$

A pseudo mean 1122 corresponding to the training data T2 is calculated by the following formula using x_{1,p}, x_{2,p}, and x_{5,p} selected from x_{1,p}, x_{3,p}, x_{4,p}, x_{5,p}, and x_{6,p} except for x_{2,p} corresponding to the training data T2, among x_{1,p}, x_{2,p}, x_{3,p}, x_{4,p}, x_{5,p}, and x_{6,p} received by the numerical conversion layer 220.

$${\tilde{μ}}_{2 , p} = \frac{1}{3} ( {x}_{1 , p} + {x}_{2 , p} + {x}_{5 , p} ) \qquad [ Mathematical Formula 13 ]$$

A pseudo mean 1123 corresponding to the training data T3 is calculated by the following formula using x_{1,p}, x_{2,p}, and x_{5,p} selected from x_{1,p}, x_{2,p}, x_{4,p}, x_{5,p}, and x_{6,p} except for x_{3,p} corresponding to the training data T3, among x_{1,p}, x_{2,p}, x_{3,p}, x_{4,p}, x_{5,p}, and x_{6,p} received by the numerical conversion layer 220.

$${\tilde{μ}}_{3 , p} = \frac{1}{3} ( {x}_{1 , p} + {x}_{2 , p} + {x}_{5 , p} ) \qquad [ Mathematical Formula 14 ]$$

In this manner, as the pseudo mean corresponding to one piece of training data of the plurality of pieces of training data, the mean of the components of the first layer outputs of the training data selected from the other training data except for the one piece of training data is calculated. In a method of selecting some training data from the other training data except for the one piece of training data, the training data may be selected randomly or may be selected in accordance with a predetermined rule.

With this pseudo mean calculation method, the value of the pseudo mean calculated and the value of the pseudo variance calculated using the pseudo mean have suppressed influence of the first layer output of the one piece of training data, and the learning effect can be expected to be improved even in a case where the batch size is small.

(3) In the above embodiment, the pseudo mean corresponding to one piece of training data of a plurality of pieces of training data in a batch is calculated using first layer outputs of all the other training data except for the one piece of training data in the batch, but it is not limited thereto. For example, the pseudo mean may be calculated using the first layer outputs of the plurality of pieces of training data including the one piece of training data.

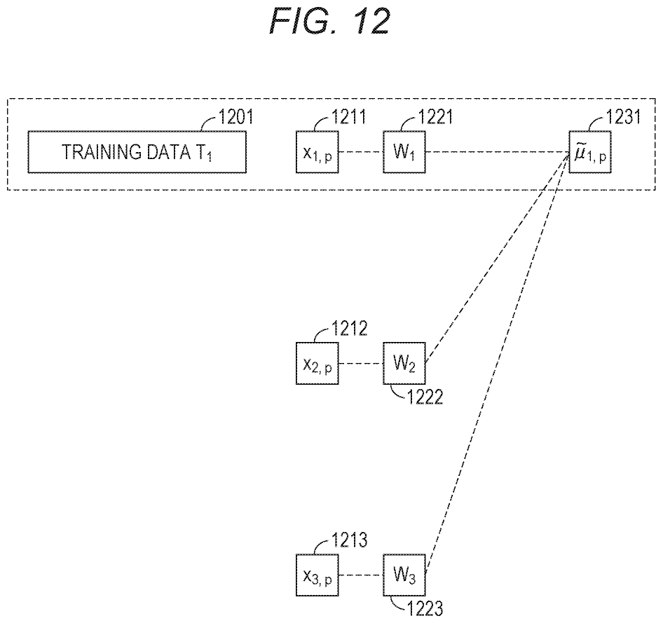

FIG. 12 illustrates a method of calculating a pseudo mean different from that of the embodiment. Here, it is assumed that the batch size is three and the training data in a batch includes pieces of training data 1201, 1202, and 1103 (training data T1, T2, and T3). A method of calculating the pseudo mean and the pseudo variance corresponding to the p-th dimension will be described, but the pseudo means corresponding to other dimensions are similarly calculated.

In batch learning, the numerical conversion layer 220 receives a component 1211 (component x_{1,p}), a component 1212 (x_{2,p}), and a component 1213 (x_{3,p}) for the p-th dimension of the first layer outputs corresponding to the training data T1, T2, and T3 of a first batch.

A pseudo mean 1231 corresponding to the training data T1 is calculated by the following formula using x_{1,p}, x_{2,p}, and x_{3,p} received by the numerical conversion layer 220.

$$[ Mathematical Formula 15 ]$$

$${\tilde{μ}}_{1 , p} = \frac{1}{{w}_{1} + {w}_{2} + {w}_{3}} ( {w}_{1} \cdot {x}_{2 , p} + {w}_{2} \cdot {x}_{3 , p} + {w}_{3} \cdot {x}_{4 , p} )$$

where w1, w2, and w3 are predetermined weights, and the weight w1 corresponding to the training data T1 is smaller than the weights corresponding to the other training data.

In this manner, as the pseudo mean corresponding to one piece of training data of the plurality of pieces of training data, the weighted average of the components of the first layer outputs of the plurality of pieces of training data including the one piece of training data. In this case, it is assumed that the weight attached to the first layer output of the one piece of training data is smaller than the weights attached to the first layer outputs of the other training data.

With this pseudo mean calculation method, the value of the pseudo mean calculated and the value of the pseudo variance calculated using the pseudo mean have suppressed influence of the first layer output of the one piece of training data, and the learning effect can be expected to be improved even in a case where the batch size is small.

(4) In the above embodiment, the first layer 210 may be a neural network layer that generates an output including a plurality of components that are each indexed by both a feature index and a spatial location index.

In this case, the numerical conversion layer 220 calculates, for each combination of the feature index and the spatial location index, a pseudo mean and a pseudo variance of the components of the first layer output having the feature index and the spatial location index. The numerical conversion layer 220 calculates, for each feature index, the arithmetic mean of a pseudo mean for a combination of the feature index and a spatial location index including the feature index. The numerical conversion layer 220 calculates, for each feature index, the arithmetic variance of a pseudo variance for a combination of the feature index and a spatial location index including the feature index.

The numerical conversion layer 220 numerically converts each component of each of the outputs of the first layer 210 using the calculated arithmetic mean and arithmetic variance to generate a numerically converted output for each of the training data in the batch. The numerical conversion layer 220 normalizes each component using the calculated arithmetic mean and arithmetic variance in the same manner as when generating an output indexed by the dimension in the above embodiment.

(5) For the p-th dimension, zₚ=γₚ yₚ+Aₚ obtained by transforming the component γₚ numerically converted using the pseudo mean and the pseudo variance using parameters γₚ and Aₚ for the p-th dimension may be provided to the second layer 230 as an output of the numerical conversion layer. The parameters γₚ and Aₚ may be constants or may be parameters defined by training of neural network system 200.

(6) The inputs of the neural network system 200 may be of different types of inputs during training and during inference. For example, user images may be trained as training data to infer video frames.

(7) In the above embodiment, the first layer 210 may generate an output by modifying an input to the first layer based on values of a set of parameters for the first layer. In addition, the second layer 230 may receive the output of the numerical conversion layer 220 and apply a nonlinear operation, that is, a nonlinear activation function to a numerical conversion layer output to generate an output. Furthermore, the first layer 210 may generate a modified first layer input by modifying the layer input based on the values of a set of parameters for the first layer, and generate an output by applying the non-linear operation to the modified first layer input before providing the numerical conversion layer 220 with the output.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### INDUSTRIAL APPLICABILITY

The present disclosure is useful for a neural network system that performs image recognition, natural language processing, speech recognition, and the like.

### REFERENCE SIGNS LIST

200 neural network system
210 first layer
220 numerical conversion layer
230 second layer

1. A neural network system implemented by one or more computers, comprising:
a first layer that generates first layer outputs of a plurality of pieces of training data,
each of the first layer outputs having a plurality of components;
a second layer; and
a numerical conversion layer disposed between the first layer and the second layer, wherein
during training of the neural network system, the numerical conversion layer:
receives the first layer outputs from the first layer,
calculates a numerical conversion parameter corresponding to each of the pieces of training data,
numerically converts each of the components of each of the first layer outputs using the numerical conversion parameter to generate a numerical conversion layer output, and
inputs the numerical conversion layer output to the second layer, and
the numerical conversion parameter corresponding to one of the pieces of training data is:
calculated from the first layer outputs of the pieces of training data except the one of the pieces of training data, or
calculated by weighting each of the first layer outputs of the pieces of training data including the one of the pieces of training data, and
a weight of one of the first layer outputs of the one of the pieces of training data is smaller than a weight of the other first layer outputs of the other pieces of training data.

2. The neural network system according to claim 1, wherein the numerical conversion parameter corresponding to the one of the pieces of training data is calculated from first layer outputs of a plurality of pieces of training data selected, from a batch including a set of the pieces of training data including the one of the pieces of training data, by a predetermined selection method to exclude the one of the pieces of training data.

3. The neural network system according to claim 2, wherein
the components of each of the first layer outputs are indexed by dimensions, and
the numerical conversion layer calculates the numerical conversion parameter by:
with respect to the pieces of training data per the batch, for each of the dimensions, calculating a mean of the components of each of the first layer outputs of the pieces of training data selected by the selection method, as a pseudo mean of the components of each of the first layer outputs, and
calculating, for each of the dimensions, a variance of the components of each of the first layer outputs using the components of each of the first layer outputs and the pseudo mean with respect to the pieces of training data per the batch.

4. The neural network system according to claim 3, wherein the numerical conversion layer generates the numerical conversion layer output by, for each of the pieces of training data, numerically converting the components of each of the first layer outputs of the pieces of training data using the pseudo mean and the variance for each of the dimensions corresponding to each of the components.

5. The neural network system according to claim 4, wherein the numerical conversion layer generates the numerical conversion layer output by of transforming the components numerically converted based on values of a set of transformation parameters for each of the dimensions.

6. The neural network system according to claim 5, wherein
after the neural network system is trained, the numerical conversion layer:
receives a new first layer output for a new neural network input generated by the first layer,
generates a new numerically converted layer output by numerically converting each of components of the new first layer output using a precalculated numerical conversion parameter,
generates a new numerical conversion layer output by converting, for each of the dimensions, each of components of the new numerically converted layer output based on a set of transformation parameters for each of the dimensions, and
newly inputs the new numerical conversion layer output to the second layer.

7. The neural network system according to claim 6, wherein the precalculated numerical conversion parameter is calculated from the first layer outputs generated by the first layer during the training of the neural network system.

8. The neural network system according to claim 6, wherein the precalculated numerical conversion parameter is calculated from the new first layer output generated by the first layer after the neural network system is trained.

9. The neural network system according to claim 7, wherein a new neural network input processed by the neural network system after the neural network system is trained is an input of a different type from the pieces of training data used to train the neural network system.

10. The neural network system according to claim 2, wherein
the components of each of the first layer outputs are indexed by a feature index and a spatial location index,
the numerical conversion layer calculates the numerical conversion parameter by:
with respect to the pieces of training data per the batch, for each combination of the feature index and the spatial location index, calculating a mean of the components of each of the first layer outputs of the pieces of training data selected by the selection method,
with respect to the pieces of training data per the batch, for each of the feature index, calculating an arithmetic mean of the mean with respect to the combination including the feature index,
for each combination of the feature index and the spatial location index, calculating a variance of the components of each of the first layer outputs using the components of each of the first layer outputs and the arithmetic mean with respect to the pieces of training data per the batch, and
for each of the feature index, calculating an arithmetic variance of the variance with respect to the combination including the feature index.

11. The neural network system according to claim 10, wherein the numerical conversion layer generates the numerical conversion layer output by, for each of the pieces of training data, numerically converting the components of each of the first layer outputs of the pieces of training data using the arithmetic mean and the arithmetic variance.

12. The neural network system according to claim 11, wherein the numerical conversion layer generates the numerical conversion layer output by converting the components numerically converted based on a set of transformation parameters for each of the feature index.

13. The neural network system according to claim 12, wherein
after the neural network system is trained, the numerical conversion layer:
receives a new first layer output for a new neural network input generated by the first layer,
generates a new numerically converted layer output by numerically converting each of components of the new first layer output using a precalculated numerical conversion parameter,
generates a new numerical conversion layer output by converting, for each of the feature index, each of components of the new numerically converted layer output based on a set of transformation parameters for each of the feature index, and
newly inputs the new numerical conversion layer output to the second layer.

14. The neural network system according to claim 2, wherein
the components of each of the first layer outputs are indexed by a feature index and a spatial location index, and
the numerical conversion layer calculates the numerical conversion parameter by:
with respect to the pieces of training data per the batch, for each of the feature index, calculating a mean of the components of each of the first layer outputs of the pieces of training data selected by the selection method, as a pseudo mean of the components of each of the first layer outputs, and
for each of the feature index, calculating a variance of the components of each of the first layer outputs using the components of each of the first layer outputs and the pseudo mean with respect to the pieces of training data per the batch.

15. The neural network system according to claim 14, wherein the numerical conversion layer generates the numerical conversion layer output by, for each of the pieces of training data, numerically converting the components of each of the first layer outputs of the pieces of training data using the pseudo mean and the variance for the feature index corresponding to each of the components.

16. The neural network system according to claim 15, wherein the numerical conversion layer generates the numerical conversion layer output by transforming the components numerically converted based on values of a set of transformation parameters for each of the feature index.

17. The neural network system according to claim 16, wherein
after the neural network system is trained, the numerical conversion layer;
receives a new first layer output for a new neural network input generated by the first layer,
generates a new numerically converted layer output by numerically converting each of components of the new first layer output using a precalculated numerical conversion parameter,
generates a new numerical conversion layer output by converting, for each of the feature index, each of components of the new numerically converted layer output based on a set of transformation parameters for each of the feature index, and
newly inputs the new numerical conversion layer output to the second layer.

18. The neural network system according to claim 1, wherein the first layer generates each of the first layer outputs by modifying a first layer input based on a set of parameters for the first layer.

19. The neural network system according to claim 18, wherein the second layer generates a second layer output by applying a non-linear operation to a batch normalization layer output.

20. The neural network system according to claim 1, wherein the first layer is a first neural network layer that generates each of the first layer outputs by modifying a first layer input based on current values of a set of parameters to generate a modified first layer input, and then applying a non-linear operation to the modified first layer input.

21. The neural network system according to claim 1, wherein during the training of the neural network system, the neural network system back propagates the numerical conversion parameter for partially adjusting a value of a parameter of the neural network system.

22. The neural network system according to claim 2, wherein the predetermined selection method selects, from the batch, some pieces of training data except the one of the pieces of training data, or all the pieces of training data.

23. A method comprising:
executing an operation implemented by the numerical conversion layer according to claim 1.

24. A non-transitory computer readable storage medium storing instructions executed by one or more computers, the instructions causing the one or more computers to function as the neural network system according to claim 1.
